(19) United States
(12) Patent Application Publication
(10) Pub. No.: US 2026/0317608 A1
(43) Pub. Date: Oct. 15, 2026

(54) LOW GLOBAL WARMING, NEAR-AZEOTROPIC BINARY BLEND REFRIGERANT

(71) Applicants: Khalifa University of Science and Technology, Abu Dhabi (AE); UNIVERSITAT ROVIRA I VIRGILI, TARRAGONA (ES)

(72) Inventors: Maria Lourdes VEGA FERNANDEZ, Abu Dhabi (AE); Ismail Issa Ismail ALKHATIB, Abu Dhabi (AE); Felix Lluis LLOVELL FERRET, Abu Dhabi (AE); Carlos ALBA GARRIGA, Abu Dhabi (AE)

(21) Appl. No.: 19/111,156

(22) PCT Filed: Jul. 21, 2023
(86) PCT No.: PCT/IB2023/057465

§ 371 Date: Mar. 12, 2025

Related U.S. Application Data
(60) Provisional application No. 63/406,114, filed on Sep. 13, 2022.

(51) Int. Cl. C09K 5/04; F25B 45/00

(52) U.S. Cl. CPC C09K 5/045; F25B 45/00; C09K 2205/22; C09K 2205/32; F25B 2345/001; F25B 2400/121

(57) ABSTRACT

Embodiments of the present disclosure provide near azeotropic, binary blends of refrigerants that have low GWP; method of retrofitting an existing heat transfer system with the said refrigerants; heat transfer systems comprising the said refrigerants, and the like. Embodiments of the present disclosure describe a refrigerant that is near azeotropic and comprises a binary blend of more than one of R1243zf, R1234ze(E), R1234yf, R152a, R1123, R32 refrigerants.

### CROSS-REFERENCE TO RELATED APPLICATION

This application claims benefit of U.S. Provisional Application No. 63/406,114 filed on Sep. 13, 2022. U.S. Provisional Application No. 63/406,114 is incorporated herein by reference. A claim of priority is made.

### BACKGROUND

Fluorocarbon-based fluids have been heavily used in a number of commercial, domestic, and industrial applications, mainly as working fluids in cooling applications for domestic and automotive air conditions, and heat transfer devices such as industrial heat pumps. However, with environmental legislation such as EU No. 517/2014 in effect in early 2022, the American Innovation and Manufacturing (AIM) act enacted in late 2020, and many other global and regional legislations, the commercialization and utilization of hydrofluorocarbons (HFCs) has been gradually phased out with new guidelines stipulating new working fluids with a global warming potential (GWP) of less than 150. Among the Green House Gases (GHGs) emitted into the atmosphere, fluorinated compounds such as hydrofluorocarbons (HFCs), mainly used in refrigeration and cooling systems, are called to be phased-out due to mandatory regulations to mitigate climate change.

Understandably, there is a need that the desirable substitute refrigerant should be effective without major engineering changes to the conventional vapor compression technology currently used with existing refrigerants. The desirable properties include:
1) Global warming potential (GWP) less than 150.
2) No Ozone Depletion Potential (ODP).
3) Non-toxic (Class A according to ASHRAE classification).
4) Non-flammable (Class 1) or mildly-flammable (Class 2L according to ASHRAE classification).
5) Pure components or near-azeotropic blends (preferably glide temperature<0.1 K, but 5-10 K are acceptable) with similar normal boiling temperature and condensation pressures of the refrigerant to be replaced.
6) Have similar volumetric cooling capacity (i.e., amount of refrigerant to deliver a specific cooling capacity), condenser pressure, and discharge line temperature as R134a or R410A, depending on the application.
7) Having similar system performance energetic efficiency, and energy consumption.

Thus far, finding a single-component refrigerant with all desirable properties is a difficult feat. Therefore, there is an urgent need for refrigerants, methods and systems that adhere to the new GWP limits, at the same time making such refrigerants cost effective and requiring minimum engineering modifications to the existing system.

### SUMMARY

Embodiments of the present disclosure provide for near azeotropic, binary blends of more than one of refrigerants R1243zf, R1234ze(E), R1234yf, R152a, R1123, R32, that have low GWP.

Embodiments of the present disclosure describe a method of retrofitting an existing heat transfer system that includes an existing refrigerant, wherein the method comprises unsealing the heat transfer system to gain access to the existing refrigerant, removing substantially all of the existing refrigerant from the heat transfer system, replacing the existing refrigerant with a refrigerant that is near-azeotropic and comprises a binary blend of more than one of R1243zf, R1234ze(E), R1234yf, R152a, R1123, R32 refrigerants, and resealing the heat transfer system.

Embodiments of the present disclosure describe a heat transfer system comprising a compressor, a condenser, and an evaporator in fluid communication and operating with an evaporator temperature (ET) from about 243 K to about 263 K; condenser temperature (CT) from about 293 K to about 315 K, and a refrigerant in said system, wherein the said refrigerant comprises a binary blend of more than one of R1243zf, R1234ze(E), R1234yf, R152a, R1123, R32 refrigerants.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. Reference is made to illustrative embodiments that are depicted in the figures, in which:

FIGS. 1(a-c) illustrate the process flow diagram for the vapor compression refrigeration cycle (VCRC) in existing system (FIG. 1(a)), Pressure-Enthalpy (PH) diagram (FIG. 1(b)) and temperature-entropy (TS) diagram (FIG. 1(c)) for near-azeotropic blends used in the present disclosure.

FIGS. 2(a-c) show Drop-in KPIs for promising drop-in replacement blends for R134a as a function of different outlet evaporator temperature, as seen from predicted VCC (FIG. 2(a)), DLT (FIG. 2(b)) and COP (FIG. 2(c)).

FIGS. 3(a-f) show the schematics for the advanced refrigeration cycles simulated in the present disclosure with liquid-to-suction line heat exchanger (LL/SL-HX) (FIG. 3(a-c) and two-stage linear compressor systems (TS-VCRC) (FIG. 3(d-f), with their corresponding PH and TS-diagrams.

FIGS. 4(a-d) show the Vapor Liquid Equilibria (VLE) of selected refrigerants binary mixtures or blends for those containing a) R32, b) R134a, c) R1234yf and d) R1234ze(E), using polar soft-SAFT (solid lines), compared to experimental data (symbols).

FIG. 5 shows the predicted Vapor-Liquid Equilibria (VLE) of the binary blend comprising R1243zf and R1234ze(E).

FIGS. 6(a-d) show the Thermodynamic properties of low GWP refrigerants, including (a) enthalpy of vaporization, (b) single-phase density, (c) isobaric heat capacity, and (d) speed of sound, for R1234ze(E), R1234yf, and R1233zd(E), with polar soft-SAFT predictions (solid lines) compared to experimental data (symbols).

FIGS. 7(a-b) present the results of the environmental impact based on the TEWI metric in SS-VCRC cycle. FIG. 7(a) shows the different major HFCs producers, and FIG. 7(b) shows selected EU-27 countries, sorted by population from left to right. The strong color represents direct emissions, while the light-equivalent color stands for indirect emissions. The colors represent the different refrigerants and blends, as per the legend inside the figures.

FIGS. 8(a-b) show Economic analysis for most promising alternatives for R134a. FIG. 8(a) shows the economic analysis for most promising alternatives for R134a for the different major HFCs producers based on total costs. FIG. 8(b) shows Economic analysis for most promising alternatives for R134a for the cycle configurations based on operating costs (left y-axis, darker colors of the bars) and environmental cost (right y-axis, lighter color of the bars) performed under the Spanish regulations, being the most restrictive within the EU-27.

FIG. 9 shows the predicted Vapor Liquid Equilibria (VLE) of the binary blend comprising R1123+R32.

FIG. 10 shows the environmental impact for blend 1 as an alternative to R410A in SS-VCRC cycle, with the bar colors corresponding to the studied benchmark refrigerants and designed blends for different major HFCs producers.

FIG. 11 shows the economic analysis for most promising alternatives for R410A for the different major HFCs producers based on total costs. The colors represent the different refrigerants and blends, as per the legend inside the figures. The different portions of the bars represent the split of the total annual cost, from bottom to top (darker to lighter colors): CAPEX, OPEX, Enviro, and set-up costs.

### DETAILED DESCRIPTION

The present disclosure relates to near azeotropic, binary blends of refrigerants that have low GWP; method of retrofitting an existing heat transfer system with the said refrigerants; heat transfer systems comprising the said refrigerants, and the like. Embodiments of the present disclosure describe a refrigerant that is near azeotropic and comprises a binary blend of more than one of R1243zf, R1234ze(E), R1234yf, R152a, R1123, R32 refrigerants.

Replacing the current commercially used third generation refrigerants with a low GWP alternative is not straightforward and might lead to retrofitting the existing system, resulting in a trade-off, often overlooked, between meeting environmental constraints and incurring additional costs or compromising system performance. To blame for this is the lack of experimental data on the physicochemical properties of alternative refrigerants, essential for their accurate technical evaluation and projection on industrial scale. This is expected as experimentally obtaining all relevant properties is quite taxing in temporal and monetary terms, given the number of different properties, varying operating conditions, and possible working fluids. As such, pragmatic and robust computational tools provide a possible remedy to overcome this hurdle, with the capability of rapidly determining potential HFCs replacements, satisfying environmental and technical requirements. With the rise of thermodynamic modeling approaches and computational power, molecular-based equations of state (EoSs) such as those routed on the statistical associating fluid theory (SAFT) have become indispensable tools in modeling the thermodynamic behavior of complex fluids. The adoption of SAFT based models as a central pillar for screening tools has been steadily growing, holding the promise of similar success when applied to screening alternative eco-friendly refrigerants as drop-in replacements under the same operating conditions and technical criteria. On another front, the physical basis of SAFT based models can enable the extraction of microlevel tendencies linked with observable physicochemical properties and technical performance. This fundamental level knowledge can effectively guide future efforts on the search of promising low GWP alternative refrigerants.

The present disclosure describes a robust framework for rapidly assessing the feasibility of replacing single-component or binary blends of third generation refrigerants HFCs with low GWP fourth generation refrigerants HFOs and HCFOs, connecting features of their molecular structure to their performance. The framework is built on the use of a molecular-based EoS, namely, polar soft-SAFT, for the holistic thermodynamic characterization of the investigated refrigerants. Once the accuracy of the model is established through comparison with available experimental data, the compatibility of third generation refrigerants with their low GWP fourth generation replacements is determined through a drop-in analysis with the objective of minimal retrofitting to the existing system. This analysis is done using technical criteria computed from properties predicted by the thermodynamic model. In addition to these technical criteria, the compatibility of refrigerants is examined in terms of molecular characteristics obtained from the model.

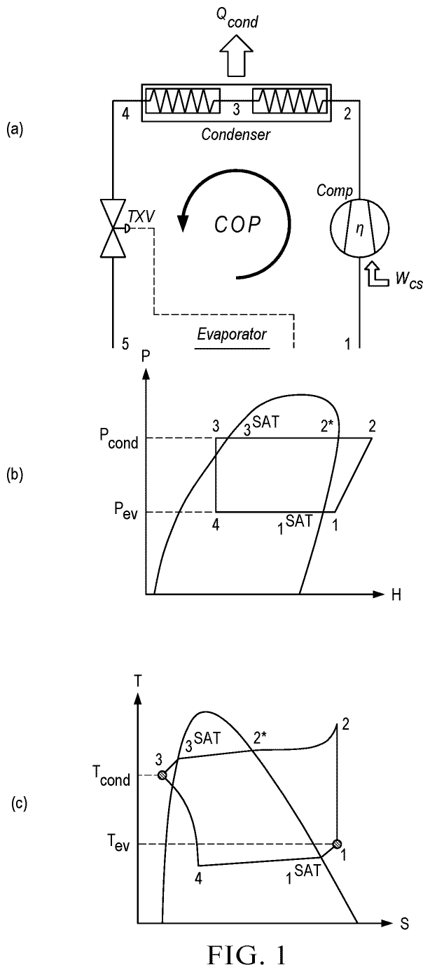

Toward assessing the compatibility of fourth generation drop-in replacements, several technical criteria can be included, granted that the technical assessment is done under the same refrigeration cycle and operating conditions as the existing system. The performance of third generation HFCs and their fourth-generation replacements HFOs and HCFOs is assessed in the present disclosure using a vapor compression refrigeration cycle (VCRC). FIG. 1(a) depicts the vapor compression refrigeration cycle. The cooling process as shown in FIG. 1(a), comprises a single-stage compressor, condenser, evaporator, and thermo-static expansion valve (TXV). The cycle starts with the isentropic compression of the refrigerant (1-2), with the superheated vapor flowing through the condenser, and releasing its sensible (2-3) and latent (3-4) heats to surrounding air to reach the saturation temperature at the condenser's pressure (2-4). Subsequently, the saturated liquid is expanded resulting in two phase vapor-liquid mixture, with the TXV regulating the refrigerant mass flow rate (4-5), routed to the isobaric evaporator with the refrigerant reaching its saturated vapor phase (5-1). The implementation of the VCRC requires assumptions on the process conditions such as, steady-state flow, fixed evaporator temperature (Tₑᵥₐₚ=270 K), fixed condenser temperature (T_{cond}=300 K), negligible heat transfer in piping, negligible superheating and subcooling effects, zero pressure drop and isobaric conditions in both condenser and evaporator, ideal isentropic efficiency in the compressor, and isenthalpic flow across the TXV, in a manner consistent with existing systems. These conditions were chosen to simulate a cooling cycle with a medium evaporation temperature (i.e., in the range of 268-283 K) and a lift temperature of 30 K to prevent heat cross between external heat sink and the corresponding heat source. The chosen technical criteria for evaluating compatibility of drop-in replacements include volumetric cooling capacity (VCC), and coefficient of performance (COP). The VCC refers to the amount of cooling per unit volume of the vapor refrigerant at the evaporator outlet, computed as

$$VCC = RE \times {ρ}_{v} \qquad ( 1 )$$

where RE is the refrigeration effect as the difference between the enthalpies of the refrigerant at evaporator outlet and inlet, while ρᵥ is the density of the saturated vapor exiting the evaporator, otherwise known as suction density. Conversely, the COP quantifies the overall efficiency of the refrigeration cycle, expressed as the cooling effect produced per unit of work,

$$COP = \frac{RE}{{W}_{c}} = \frac{{H}_{evap , out} - {H}_{cond , out}}{( \frac{{H}_{comp , out} - {H}_{evap , out}}{⋮η⋮} )} \qquad ( 2 )$$

where W_{c} is the actual compressor work, and η is the real compressor efficiency, which in the present disclosure is assumed to be ideal (i.e., η=1.0). The computations of these criteria require pressure enthalpy (PH) diagram ((FIG. 1(b)), and temperature-entropy (TS) diagram (FIG. 1(c)) and physicochemical properties that were predicted using polar soft-SAFT for all studied refrigerants, under the imposed conditions of the cooling cycle. Refrigerants are deemed compatible if the values of their VCC are similar, denoting equivalent refrigerant volume handled by the compressor without need for compressor retrofitting. Additionally, the replacement refrigerant should possess either a similar or higher COP value compared to the refrigerant to be replaced, denoting either a similar or higher cycle efficiency. For the most compatible refrigerants, other properties with impact on technical performance are examined to gain additional insight on other possible technical trade-offs. These properties include normal boiling point (NBP), condenser pressure (P_{cond}), suction density (ρᵥ), liquid specific heat (c_{P}), and refrigeration effect (RE). The normal boiling point measures the ease of vaporizing the refrigerant upon absorbing heat, which should be minimized for low-medium temperature applications, as high NBP would require operating the compressor at low pressures or even vacuum to facilitate vaporization, at the expense of higher operating costs. Similarly, the condenser pressure should also be minimized to reduce the compression power and the operating costs, while the suction density relates to the density of the saturated vapor exiting the evaporator, which should be maximized to reduce the size of the compressor and required capital costs. The specific heat of the refrigerant at liquid state represents the amount of heat required to increase the temperature of the refrigerant by one temperature unit (e.g., 1 K), with lower specific heat being preferred as it reduces the amount of heat required to change the temperature of the refrigerant. This is defined as the enthalpy difference of the saturated liquid leaving the condenser at T_{cond} (H_{cond,out}) and the subcooled liquid leaving the condenser at (T_{cond}−1 K) (H_{cond,out}−1 K) at isobaric conditions. Lastly, the refrigeration effect is a measure of the amount of latent heat absorbed in the evaporator, corresponding to the cooling capacity of the refrigerant, which should be maximized to ensure higher extracted heat or lower refrigerant mass flow rates. It is important to remark that all systems discussed in the present disclosure require the use of polyol ester (POE)-based lubricant oils, more precisely pentaerythritol esters (PECs), to ensure miscibility, lubricity, and chemical stability of the resulting refrigerant-PEC oil pair. All the examined drop-in replacements are compatible with PEC; otherwise, a thorough refrigerant-PEC oil compatibility analysis would be required.

All thermophysical properties of the selected refrigerants considered in the present disclosure have been modeled using the polar soft-SAFT Equation of State (EoS), an extension of the original soft-SAFT equation. Table 1 summarizes the designation and IUPAC names of the refrigerants related to the present disclosure.

TABLE 1
Summary of the HFCs and HPOs included in this work.

| ASHRAE | | ASHRAE | |
|---|---|---|---|
| designation | IUPAC Name | designation | IUPAC Name |
| 3^{rd} gen. HFCs | | 4^{th} gen. HFOs | |
| R32 | Difluoromethane | R1123 | 1,1,2-trifluoroethene |
| R23 | Trifluoromethane | R1243zf | 3,3,3-trifluoroprop-1-ene |
| R161 | 1-fluoroethane | R1234yf | 2,3,3,3-tetrafluoroprop-1-ene |
| R152a | 1,1-difluoroethane | R1234ze(E) | trans-1,3,3,3-tetrafluoroprop-1-ene |
| R134a | 1,1,1,2-tetrafluoroethane | | |
| R125 | 1,1,1,2,2-pentafluoroethane | | |
| R245fa | 1,1,1,3,3-pentafluoropropane | | |
| R236fa | 1,1,1,3,33-hexafluoropropane | | |
| R227ea | 1,1,1,2,3,3-heptafluoropropane | | |

The present disclosure appreciates the need for compositions, particularly refrigerant compositions that are highly advantageous in vapor compression cooling systems, particularly refrigerant systems of the type that have been used with or designed for use with R134a or R410A. The embodiments of the present disclosure relate to compositions, methods, and heat transfer systems having utility particularly in refrigeration applications with particular benefit in low-medium temperature refrigeration application.

Certain embodiments of the present disclosure relate in particular aspects to refrigerant compositions useful in systems for replacing the refrigerant R134 or R410A for refrigeration (cooling) applications and to retrofitting low-medium temperature refrigeration systems. The embodiments of the present disclosure further include systems designed for use with R134a or R410A, comprising, but not limited to automotive and domestic air conditioning systems or high pressure commercial and industrial refrigeration.

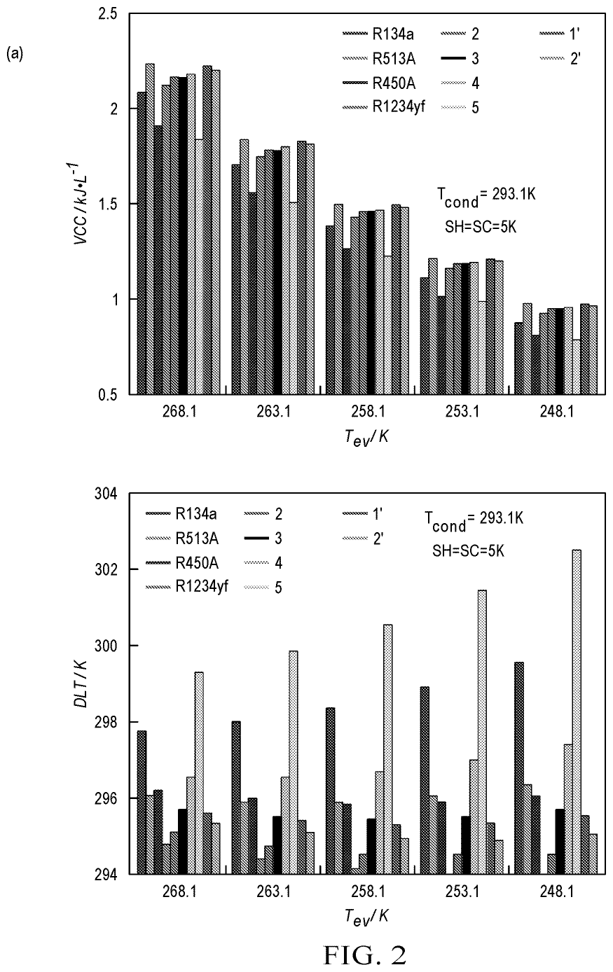

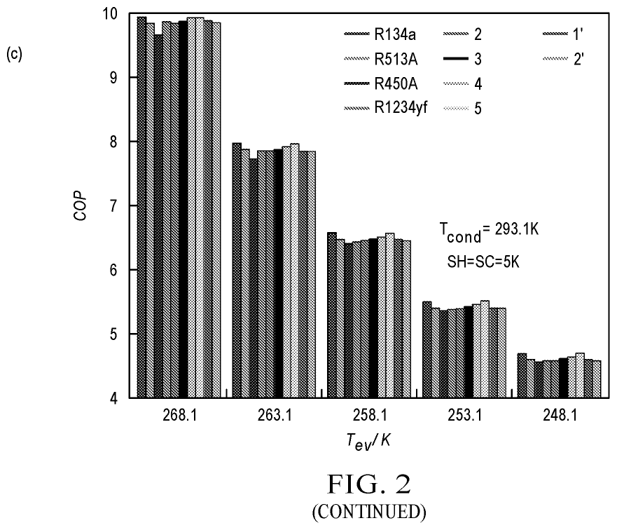

The initial screening of the 342 combinations of blends encompassing the 38 mixtures with different proportions was based on three conditions: (1) non-toxic, low-GWP blends, either GWP<150 (study A), or 150<GWP<500 (study B), (2) TG≤0.1 K at a pressure range of (0.1-3 MPa), and (3) A1 or A2L flammability class. With these criteria, 12 candidates were identified, with 8 blends for study A, and 4 for study B, included in Table 2. A compatibility analysis was performed accounting for the flammability, thermophysical properties, technical performance criteria, and drop-in KPIs of all promising blends as provided in Table 2′. The most compatible blends (>90%) designed in the present disclosure, for replacing R134a, include blends 2-5, and blends 1′ and 2′, with the highest compatibility seen with blend 3, outperforming the commercial blends R513A and R450A in addition to single-component refrigerants. In contrast, the only feasible blend for replacing R410A was blend 1, achieving similar compatibility ratio (73%) to R32. The results of the ranking were consistent irrespective of the chosen operating conditions, as seen from predicted VCC (FIG. 2(a)), DLT (FIG. (2b)) and COP (FIG. 2(c)) values as a function of the outlet evaporator temperature in FIGS. 2(a-c).

TABLE 2
Short listed refrigerant blends and their compositions
based on initial screening criteria class

| | | | | | |
|---|---|---|---|---|---|
| | | | | | ASHRAE |
| ID | Blend | wt. %^{±} | GWP | T_{G} (K)* | class |

Study A

| | | | | | |
|---|---|---|---|---|---|
| 1 | R1123 + R32 | 90.0 | 70 | 0.099 | A1 |
| 2 | R1234yf + R134a | 90.0 | 130 | 0.010 | A1 |
| 3 | R1234yf + R152a | 90.0 | 14 | 0.004 | A2L |
| 4 | | 80.0 | 28 | 0.067 | |
| 5 | R1243zf + R1234ze(E) | 60.0 | <1 | 0.041 | A2L |
| 6 | | 70.0 | | 0.012 | |
| 7 | | 80.0 | | 0.002 | |
| 8 | | 90.0 | | 0.000 | |

Study B

| | | | | | |
|---|---|---|---|---|---|
| 1′ | R1234yf + R134a | 70.0 | 390 | 0.019 | A1 |
| 2′ | | 80.0 | 260 | 0.000 | |
| 3′ | R1234ze(E) + R227ea | 90.0 | 336 | 0.013 | A1 |
| 4′ | R152a + R134a | 80.0 | 370 | 0.084 | A2L |

^{±}The mass fraction for the 1^{st} component in the blend.
*Obtained at atmospheric pressure (0.1 MPa).

TABLE 2′
Compatibility analysis of promising blends designed for replacing R134a and R410A. Color codes
designate null (green), partial (yellow), and complete (red) - retrofitting required.

| | | R32 | R513A | R450A | R1234yf | R1234ze(E) | R1225ye(Z) | 1 | 2 | 3 | 4 | 5 | 6 | 7 | 8 | 1′ | 2′ | 3′ | 4′ |
|---|---|---|---|---|---|---|---|---|---|---|---|---|---|---|---|---|---|---|---|
| Perfor- | II | 3 | 5 | 5 | 4 | 4 | 5 | 5 | 5 | 4 | 4 | 3 | 3 | 2 | 2 | 5 | 5 | 5 | 3 |
| mance | NBP | 4 | 2 | 2 | 2 | 5 | 1 | 5 | 2 | 2 | 2 | 1 | 2 | 2 | 2 | 2 | 2 | 1 | 2 |
| 1: Poor | P_{R} | 4 | 3 | 2 | 3 | 2 | 1 | 5 | 3 | 3 | 3 | 2 | 2 | 2 | 2 | 3 | 3 | 2 | 2 |
| 2: Bad | ρᵥ | 5 | 3 | 2 | 3 | 2 | 1 | 5 | 3 | 3 | 3 | 2 | 2 | 2 | 2 | 3 | 3 | 1 | 2 |
| 3: Fair | RE | 4 | 1 | 1 | 1 | 1 | 1 | 1 | 1 | 1 | 1 | 2 | 2 | 2 | 2 | 1 | 1 | 1 | 3 |
| 4: Good | PPTR | 3 | 3 | 2 | 3 | 4 | 3 | 1 | 3 | 3 | 4 | 4 | 4 | 4 | 5 | 3 | 3 | 4 | 5 |
| 5: Excel- | COP | 3 | 3 | 2 | 3 | 4 | 3 | 1 | 3 | 3 | 4 | 4 | 4 | 4 | 5 | 3 | 3 | 4 | 5 |
| lent | [symbol] | 3 | 3 | 2 | 3 | 4 | 3 | 1 | 3 | 3 | 4 | 5 | 4 | 4 | 5 | 3 | 3 | 4 | 5 |
| Drop-in | VCC | 1 | 4 | 4 | 5 | 2 | 2 | 1 | 5 | 5 | 4 | 4 | 4 | 4 | 4 | 4 | 4 | 2 | 4 |
| KPIs | P_{cond} | 1 | 5 | 5 | 5 | 4 | 4 | 1 | 5 | 5 | 5 | 5 | 5 | 5 | 5 | 5 | 5 | 4 | 5 |
| R134a | DLT | 1 | 5 | 5 | 4 | 3 | 2 | 3 | 4 | 5 | 5 | 5 | 4 | 3 | 2 | 5 | 5 | 3 | 3 |
| Drop-in | VCC | 5 | 1 | 1 | 1 | 1 | 1 | 4 | 1 | 1 | 1 | 1 | 1 | 1 | 1 | 1 | 1 | 1 | 1 |
| KPIs | P_{cond} | 5 | 3 | 2 | 3 | 2 | 2 | 4 | 3 | 3 | 3 | 2 | 2 | 2 | 2 | 3 | 3 | 2 | 2 |
| R410A | DLT | 1 | 1 | 1 | 1 | 1 | 1 | 3 | 1 | 1 | 1 | 2 | 2 | 3 | 4 | 1 | 1 | 1 | 4 |
| Compati- | R134a/% | 20 | 93 | 93 | 93 | 60 | 53 | 33 | 93 | 100 | 93 | 93 | 87 | 80 | 73 | 93 | 93 | 60 | 80 |
| bility | R410A/% | 73 | 33 | 27 | 33 | 27 | 37 | 73 | 33 | 33 | 33 | 33 | 33 | 40 | 47 | 33 | 33 | 27 | 47 |

[symbol]

indicates data missing or illegible when filed

Following completion of the aforementioned investigation, the binary blend refrigerants comprising more than one of R1243zf, R1234ze(E), R1234yf, R152a, R1123, R32 refrigerants, were of interest. Embodiments of the present disclosure describe azeotropic-like, binary blend refrigerant compositions, that comprise: (a) from about 60% to about 90% by weight of R1243zf (3,3,3-trifluoroprop-1-ene, C₃F₃H₃) and (b) from about 10% to about 40% by weight of R1234ze(E) (trans-1,3,3,3-tetrafluoroprop-1-ene, C₃H₂F₄). The amount of (a) improves one or more of a global warming potential, capacity, efficiency, discharge temperature, discharge pressure, and/or energy consumption of the composition, particularly in a low or medium temperature refrigeration system and as compared to the refrigerant R134a.

Embodiments of the present disclosure also describe near azeotropic, binary blend refrigerant compositions, that comprise: (c) from about 80% to about 90% by weight of R1234yf (2,3,3,3-tetrafluoroprop-1-ene, C₃H₂F₄) and (d) from about 10% to about 20% by weight of R152a (1,1-difluoroethane, C₂H₄F₂). The amount of (c) improves one or more of a global warming potential, capacity, efficiency, discharge temperature, discharge pressure, and/or energy consumption of the composition, particularly in a low or medium temperature refrigeration system and as compared to the refrigerant R134a.

In certain embodiments, the present disclosure describes near azeotropic, binary blend refrigerant compositions, that comprise: (e) about 90% by weight of R1123 (1,1,2-trifluoroethene, C₂HF₃) and (f) about 10% by weight of R32 (Difluoromethane). The composition improves one or more of a global warming potential, capacity, efficiency, discharge temperature, discharge pressure, and/or energy consumption of the composition, particularly in a low or medium temperature refrigeration system and as compared to the refrigerant R410A.

Applicants have found the combination of components in the present compositions, especially within the preferred ranges specified herein, are capable of at once achieving a combination of important and difficult to achieve refrigerant performance properties that cannot be achieved by any one of the components alone, including particularly low GWP. By way of non-limiting example, Table 3 illustrates the substantial improvement in GWP exhibited by certain compositions of the present disclosure in comparison to GWP of R134a and R410A. The embodiments of the present disclosure depicted in Objects (1) and (2) in Table 3 can be directly used as replacements for existing vapor compression systems with R134a without any engineering changes to existing systems, and maintaining relatively similar volumetric cooling capacity, discharge line temperature, condenser pressure, but with negligible GWP, and higher flammability than R134a. The flammability rating of Objects (1) and (2) are classified as mild-flammable (rating 2L) according to ASHRAE classification compared to the non-flammable rating of R134a (rating 1). Object (3) in Table 3 can be used for replacing systems with R410A with minimal retrofitting costs, in addition to similar flammability rating to R410A.

TABLE 3
Compositions of binary blend refrigerants and their GWP

| | Composition of the Invention (Weight | | GWP as | GWP as |
|---|---|---|---|---|
| | fraction, based on identified | | percentage of | percentage of |
| Object | components) | GWP | R134a GWP | R410A GWP |
| — | R134a | 1430 | — | — |
| — | R410A | 2088 | — | — |
| Object 1.1 | 60 wt. % R1243zf + 40 wt. % R1234ze(E) | <1 | 0.00% | — |
| Object 1.2 | 70 wt. % R1243zf + 30 wt. % R1234ze(E) | <1 | 0.00% | — |
| Object 1.3 | 80 wt. % R1243zf + 20 wt. % R1234ze(E) | <1 | 0.00% | — |
| Object 1.4 | 90 wt. % R1243zf + 10 wt. % R1234ze(E) | <1 | 0.00% | — |
| Object 2.1 | 90 wt. % R1234yf + 10 wt. % R152a | 14 | 0.98% | — |
| Object 2.2 | 80 wt. % R1234yf + 20 wt. % R152a | 25 | 1.96% | — |
| Object 3 | 90 wt. % R1123 + 10 wt. % R32 | 70 | — | 3.35% |

The preferred compositions of binary blend of refrigerants of the present disclosure tend to exhibit many of the desirable characteristics for R134a (objects 1 and 2) and R410A (Object 3), having a GWP that is substantially lower than that of R134a or R410A while at the same time having a capacity, efficiency, energy consumption, discharge temperature and/or condenser pressure that is substantially similar or substantially matches to R134a or R410A. Certain other preferred compositions of the present disclosure all exhibit a glide temperature close to 0.1 K at variable pressure ranges typical for systems operated with R134a or R410A, ensuring their near-azeotropic behavior. In other words, blends acting as a single pure substance in the refrigeration cycle.

In certain embodiments of the present disclosure, a low temperature refrigeration system is used herein to refer to a refrigeration system that utilizes one or more compressors and operates under or within the following conditions:
1. Condenser temperature of about 293 K to about 315 K.
2. Evaporator temperature of about 243 K to about 263 K.
3. Degree of superheating at evaporator outlet of 5 K
4. Degree of subcooling at condenser outlet of 5 K
   The embodiments can be best represented by the basic vapor compression cooling cycle typically operated in existing systems, showcased in FIGS. 1(a-c). Table 4 below illustrates some key performance characteristics of the present invention compared to existing systems operated with R134a and R410A. These include volumetric cooling capacity (VCC), discharge line temperature (DLT), condenser pressure (P_{cond}) and coefficient of performance (COP), with either R134a and R410A having 100% VCC, 100% DLT, 100% P_{cond}, and 100% COP.

TABLE 4
Key performance characteristics of the selected binary blends

| | Composition of the Invention | | | | | |
|---|---|---|---|---|---|---|
| | (Weight fraction, based on | | VCC | DLT | Pcond | COP |
| Object | identified components) | GWP | (%) | (%) | (%) | (%) |
| — | R134a | 1430 | 100% | 100%- | 100%- | 100%- |
| — | R410A | 2088 | 100% | 100% | 100% | 100% |
| Object 1.1 | 60 wt. % R1243zf + 40 wt. % | <1 | 88% | 100% | 88% | 100% |
| | R1234ze(E) | | | | | |
| Object 1.2 | 70 wt. % R1243zf + 30 wt. % | <1 | 89% | 101% | 89% | 100% |
| | R1234ze(E) | | | | | |
| Object 1.3 | 80 wt. % R1243zf + 20 wt. % | <1 | 90% | 101% | 89% | 100% |
| | R1234ze(E) | | | | | |
| Object 1.4 | 90 wt. % R1243zf + 10 wt. % | <1 | 90% | 101% | 89% | 100% |
| | R1234ze(E) | | | | | |
| Object 2.1 | 90 wt. % R1234yf + 10 wt. % R152a | 14 | 104% | 100% | 107% | 99% |
| Object 2.2 | 80 wt. % R1234yt + 20 wt. % R152a | 25 | 103% | 99% | 106% | 99% |
| Object 3* | 90 wt. % R1123 + 10 wt. % R32 | 70 | 115% | 99% | 122% | 101% |

*Object 3 is compared to R410A as a replacement, while the remaining objects are compared to R134a

As seen from Table 4, the embodiments of the present disclosure are capable of at once achieving many of the important refrigeration system performance parameters close to the parameters for R134a or R410A, and in particular sufficiently close to permit such compositions to be used as a drop-in replacement for R134a or R410A in low temperature refrigeration systems or use in such existing systems with only minor system modifications. Since many existing systems have been designed for R134a or R410A, those skilled in the art will appreciate the substantial advantage of a refrigerant with low GWP and similar efficiency which can be used as replacement for R134a or R410A with relatively minimal modifications to the system.

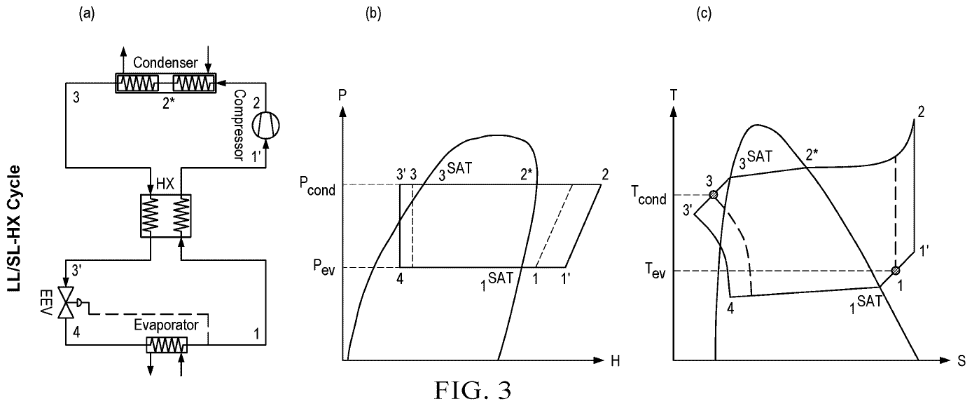

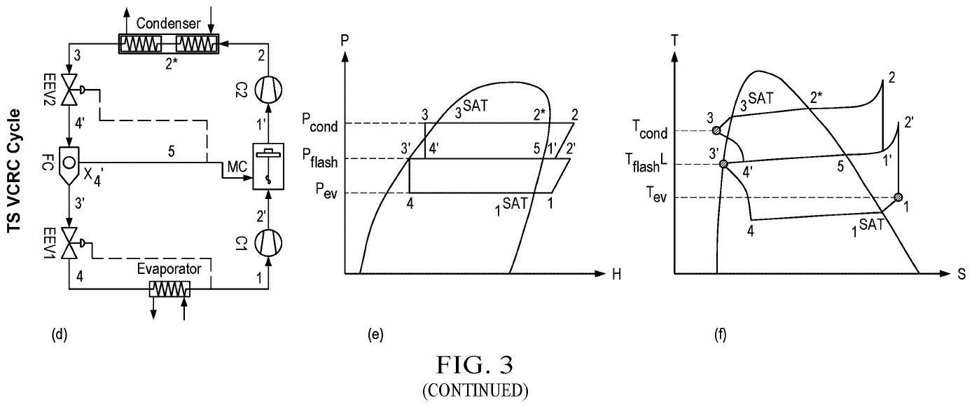

In certain embodiments, similar results with the same objects of Table 4 of the present disclosure were achieved when operated with advanced cooling cycles, including, liquid-to-suction line heat exchanger cycles (LL/SL-HX) and two-stage linear compressor systems (TS-VCRC). FIGS. 3(a-f) show the schematics for the advanced refrigeration cycles simulated in the present disclosure with LL/SL-HX (FIGS. 3(a-c)) and TSVCRC (FIGS. 3(d-f)), with their corresponding PH and TS-diagrams. Table 5 shows the key technical performance criteria for evaluating commercial refrigerants, and the embodiments of blends designed (with their ID) in the three refrigeration cycles of the present disclosure.

TABLE 5
Key technical performance criteria for evaluating commercial refrigerants,
and blends designed in the three refrigeration cycles
Commercial refrigerants

| Cycle | Metrics | R134a | R410A | R32 | R513A | R450A | R1234yf |
|---|---|---|---|---|---|---|---|
| SS- | VCC/kJ · L⁻¹ | 1.702 | 4.3412 | 4.5190 | 1.833 | 1.556 | 1.745 |
| VCRC | DLT/K | 298.00 | 306.35 | 316.55 | 295.90 | 296.00 | 294.40 |
| | RE/kJ · kg⁻¹ | 177.36 | 200.87 | 301.06 | 154.94 | 162.72 | 142.38 |
| | w_{comp}/kJ · kg⁻¹ | 22.27 | 26.36 | 38.45 | 19.69 | 21.05 | 18.13 |
| | COP | 7.96 | 7.62 | 7.83 | 7.87 | 7.73 | 7.85 |
| LL/SL- | VCC/kJ · L⁻¹ | 1.717 | 4.3354 | 4.4527 | 1.861 | 1.580 | 1.779 |
| HX | DLT/K | 310.200 | 318.50 | 329.20 | 307.90 | 308.15 | 306.25 |
| | RE/kJ · kg⁻¹ | 188.18 | 212.56 | 313.73 | 165.66 | 173.73 | 153.00 |
| | w_{comp}/kJ · kg⁻¹ | 23.49 | 27.95 | 40.66 | 20.80 | 22.16 | 19.14 |
| | COP | 8.01 | 7.61 | 7.72 | 7.96 | 7.84 | 7.99 |
| TS- | VCC/kJ · L⁻¹ | 1.707 | 4.3486 | 4.5221 | 1.839 | 1.562 | 1.751 |
| VCRC | DLT/K | 297.65 | 305.65 | 315.65 | 295.60 | 295.65 | 294.15 |
| | RE/kJ · kg⁻¹ | 177.85 | 201.21 | 301.27 | 155.45 | 163.31 | 142.90 |
| | w_{comp}/kJ · kg⁻¹ | 21.39 | 25.12 | 37.28 | 18.86 | 20.09 | 17.44 |
| | COP | 8.31 | 8.01 | 8.08 | 8.24 | 8.13 | 8.19 |

Refrigerants blends designed in this work

| Cycle | Metrics | 1 | 2 | 3 | 4 | 5 | 1′ | 2′ |
|---|---|---|---|---|---|---|---|---|
| SS- | VCC/kJ · L⁻¹ | 5.0441 | 1.780 | 1.779 | 1.792 | 1.504 | 1.826 | 1.808 |
| VCRC | DLT/K | 302.30 | 294.75 | 295.5 | 296.55 | 299.85 | 295.40 | 295.10 |
| | RE/kJ · kg⁻¹ | 165.28 | 144.84 | 154.97 | 168.05 | 176.87 | 150.45 | 147.53 |
| | w_{comp}/kJ · kg⁻¹ | 21.89 | 18.46 | 19.70 | 21.23 | 22.21 | 19.15 | 18.81 |
| | COP | 7.55 | 7.85 | 7.86 | 7.92 | 7.96 | 7.86 | 7.84 |
| LL/SL- | VCC/kJ · L⁻¹ | 5.0841 | 1.813 | 1.807 | 1.816 | 1.512 | 1.856 | 1.840 |
| HX | DLT/K | 314.10 | 306.65 | 307.40 | 308.50 | 312.05 | 307.35 | 307.00 |
| | RE/kJ · kg⁻¹ | 177.31 | 155.49 | 165.91 | 179.31 | 187.03 | 161.15 | 158.20 |
| | w_{comp}/kJ · kg⁻¹ | 23.34 | 19.52 | 20.77 | 22.41 | 23.37 | 20.23 | 19.86 |
| | COP | 7.60 | 7.97 | 7.99 | 8.00 | 8.00 | 7.97 | 7.97 |
| TS- | VCC/kJ · L⁻¹ | 5.0540 | 1.786 | 1.784 | 1.798 | 1.507 | 1.832 | 1.814 |
| VCRC | DLT/K | 301.65 | 294.55 | 295.10 | 296.20 | 299.45 | 295.00 | 294.80 |
| | RE/kJ · kg⁻¹ | 165.61 | 145.37 | 155.48 | 168.56 | 177.30 | 150.97 | 148.05 |
| | w_{comp}/kJ · kg⁻¹ | 20.81 | 17.73 | 18.76 | 20.35 | 21.42 | 18.21 | 17.98 |
| | COP | 7.96 | 8.20 | 8.29 | 8.28 | 8.28 | 8.29 | 8.23 |

In certain embodiments, the present disclosure provides retrofitting methods which comprise: unsealing the heat transfer system to gain access to the existing refrigerant (R134a or R410A); removing substantially all of the existing refrigerant from the heat transfer system; replacing the existing refrigerant with a refrigerant that is near-azeotropic and comprises a binary blend of more than one of R1243zf, R1234ze(E), R1234yf, R152a, R1123, R32 refrigerants; and resealing the heat transfer system. The retrofitting methods occur preferably without substantial modification of the systems and even more preferably without any change in major system components, such as compressors, condensers, evaporators, and expansions valves. It is important in certain embodiments that such systems are capable of exhibiting reliable system operating parameters with drop-in refrigerants, such operating parameters include:
1) Volumetric cooling capacity, of about 100% or less for existing systems with R134a or R410A. This is important to allow the use of existing pressure components. (compressor) without major modifications.
2) High pressure side (Condenser pressure) that is within 105% and even preferably within 103% of the high pressure of systems using R134a or R410A. This is important in such embodiments as it allows the use of existing pressure components.
3) Discharge temperature that is preferably within 100% or lower than for systems with R134a or R410A. This permits the use of existing equipment without activation of thermal protection aspects of the systems designed to protect the compressor.

Embodiments of the present disclosure describe methods of retrofitting an existing system, wherein the said binary blend has a composition of 60% to about 90% by weight of R1243zf, and a remainder of said refrigerant is R1234ze(E). Yet other embodiments of the present disclosure describe methods, wherein the binary blend has a composition of 80% to about 90% by weight of R1234yf, and a remainder of said refrigerant R152a. Certain embodiments of the present disclosure describe methods, wherein the binary blend has a composition of 90% by weight of R1123, and a remainder of said refrigerant R32.

Embodiments of the present disclosure describe methods, wherein the binary blend a) has a global warming potential of less than 150, b) has an ozone depletion potential of zero, c) has a safety classification of A2L or A1, d) is non-toxic according to ASHRAE classification.

Embodiments of the present disclosure describe a method as mentioned above, wherein the binary blend has a Glide Temperature of <0.1 K.

Certain embodiments of the method described in the present disclosure, comprise a system, wherein the degree of superheating at evaporator outlet is about 5 K and the degree of subcooling at the condenser outlet is about 5 K.

Embodiments of the present disclosure describe a method of retrofitting an existing system, wherein the system comprises a low to medium refrigeration system and has cooling applications.

Embodiments of the present disclosure further describe a method, wherein the system comprises a domestic or automotive air conditioning system. In certain embodiments of the present disclosure, the method of retrofitting an existing system comprises high pressure commercial or industrial refrigeration system.

Embodiments of the present disclosure also comprises the method, wherein the system comprises one operated with advanced cooling cycles and including liquid-line/suction line heat exchanger (LL/SL HX) cycles. Yet other embodiments describe the method, wherein the system comprises two-stage linear compressor systems. The methods of retrofitting an existing system with the binary blends described in the present disclosure improves one or more of a global warming potential, capacity, efficiency, discharge temperature, discharge pressure, and/or energy consumption of the composition, particularly in a low or medium temperature refrigeration system and as compared to the refrigerant R134a or R410A.

Embodiments of the present disclosure describe a heat transfer system comprising a compressor, a condenser, and an evaporator in fluid communication and operating with an evaporator temperature (ET) from about 243 K to about 263 K; condenser temperature (CT) from about 293 K to about 315 K, and a refrigerant in said system, said refrigerant comprises a binary blend of more than one of R1243zf, R1234ze(E), R1234yf, R152a, R1123, R32 refrigerants.

The embodiment according to the present disclosure comprises a system, wherein the degree of superheating at evaporator outlet is about 5 K and the degree of subcooling at the condenser outlet is about 5 K.

Embodiments of the present disclosure describe a retrofitted system, wherein the said binary blend has a composition of 60% to about 90% by weight of R1243zf, and a remainder of said refrigerant is R1234ze(E). Yet other embodiments of the present disclosure describe system, wherein the binary blend has a composition of 80% to about 90% by weight of R1234yf, and a remainder of said refrigerant R152a. Certain embodiments of the present disclosure describe systems, wherein the binary blend has a composition of 90% by weight of R1123, and a remainder of said refrigerant R32.

Embodiments of the present disclosure describe a retrofitted system, wherein the binary blend a) has a global warming potential of less than 150, b) has an ozone depletion potential of zero, c) has a safety classification of A2L or A1, d) is non-toxic according to ASHRAE classification.

Embodiments of the present disclosure describe a retrofitted system, wherein the degree of superheating at evaporator outlet is about 5 K and the degree of subcooling at the condenser outlet is about 5 K.

Embodiments of the present disclosure describe a retrofitted system as mentioned above wherein the binary blend has a Glide Temperature of <0.1 K.

Embodiments of the present disclosure describe a retrofitted system, wherein the system comprises a low to medium refrigeration system and has cooling applications.

Embodiments of the present disclosure further describe a retrofitted system, wherein the system comprises a domestic or automotive air conditioning system. In certain embodiments of the present disclosure, retrofitting an existing system comprises high pressure commercial or industrial refrigeration system.

Embodiments of the present disclosure also comprises retrofitting an existing system, wherein the system comprises one operated with advanced cooling cycles and including liquid-line/suction line heat exchanger cycles. Yet other embodiments describe the system wherein the system comprises two-stage linear compressor systems. The methods of retrofitting an existing system with the binary blends described in the present disclosure improves one or more of a global warming potential, capacity, efficiency, discharge temperature, discharge pressure, and/or energy consumption of the composition, particularly in a low or medium temperature refrigeration system and as compared to the refrigerant R134a or R410A.

Embodiments of the present disclosure comprise binary blends that could be used as drop-in replacements in the existing systems containing R134a and/or R410A, with minimal modification to the existing system.

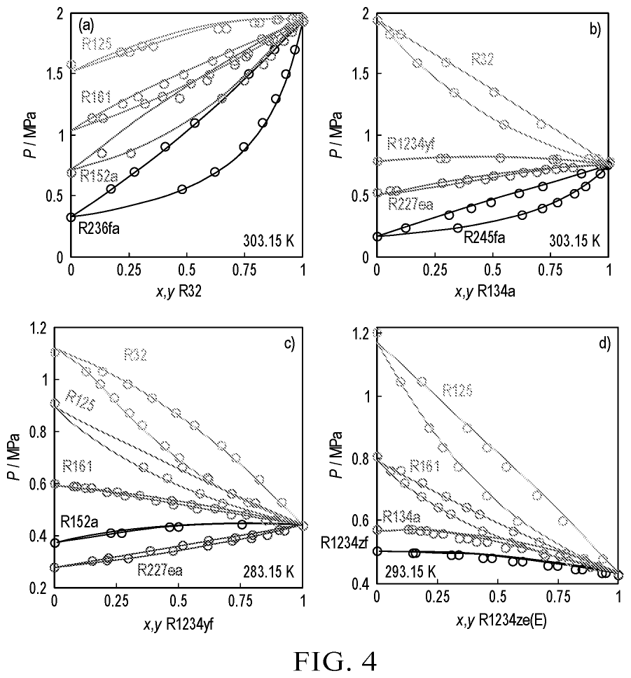

In the embodiments of the present disclosure, the reliability of polar soft-SAFT in modeling the thermodynamic behavior of refrigerant binary blends is validated to ensure high fidelity in model predictions for all thermodynamic state variables used in the subsequent technical evaluation for the suitability of identified promising refrigerant blends. The phase equilibria of selected binary mixtures with R32, R134a, R1234yf, and R1234ze(E), depicted in FIGS. 4(a-d), demonstrated the predictive accuracy of polar soft-SAFT from the highly precise correlations of experimental vapor liquid equilibria (VLE) data with little to no-calibration to the present data, simply from the molecular parameters of the pure refrigerants.

### EXAMPLES

The following examples are provided for the purpose of illustrating the present invention but without limiting the scope thereof.

### Example 1

### Cooling Application of Binary Blend Comprising R1243zf and R1234Ze (E)

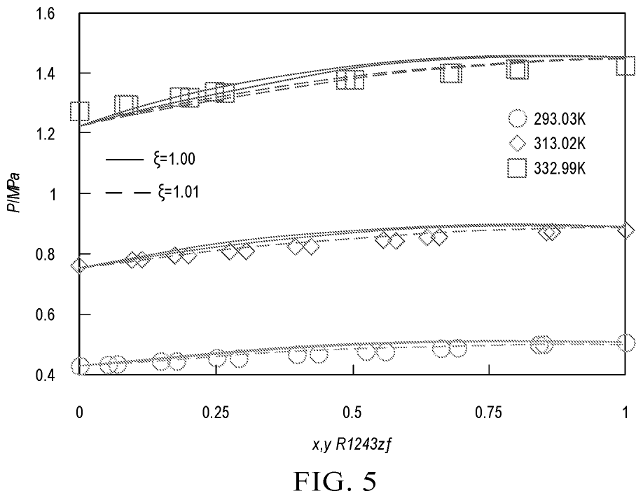

The strength of using molecular-based EoSs, even if some limited experimental data are needed for parametrization, is that once the Coarse Grained (CG) molecular models are developed, they can be used in a fully predictive manner to obtain other thermodynamic properties not included in the parametrization. These predictions typically serve as another layer of reliability and accuracy testing, especially in the case of first and second order derivative properties, due to their heightened sensitivity to errors in modeling the vapor-liquid equilibria (VLE) of the pure fluid. In this example comprising the binary blend of R1243zf and R1234ze (E), FIG. 5 shows the predicted VLE of the blend. In FIG. 5, symbols are experimental data and lines are polar soft SAFT calculations. The model performance was obtained for said binary blend, with their polar soft-SAFT computed coexisting densities and vapor pressure included in FIG. 5.

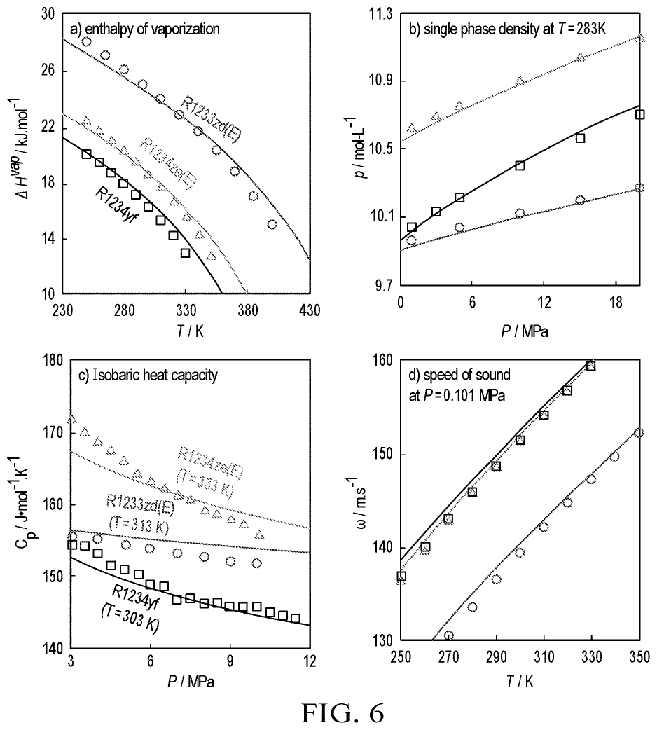

The additional predicted properties for the modeled refrigerants, include enthalpy of vaporization (ΔHᵥₐₚ), single phase density, isobaric heat capacity (c_{P}), and speed of sound (ω), as provided in FIGS. 6(a-d), for selected fourth generation refrigerants, R1234yf, R1234ze(E), and R1233zd(E). FIGS. 6(a-d) show the Thermodynamic properties of low GWP refrigerants, including (a) enthalpy of vaporization, (b) single-phase density, (c) isobaric heat capacity, and (d) speed of sound, for R1234ze(E), R1234yf, and R1233zd(E), with polar soft-SAFT predictions (solid lines) compared to experimental data (symbols). The agreement between polar soft-SAFT predictions and experimental data is excellent [Average Absolute Deviation (AAD)=1.5%] for enthalpy of vaporization, single-phase density, and speed of sound, while the deviations for predicted isobaric heat capacity are within an acceptable 5%, further attesting the accuracy and predictive capability of the equation in modeling refrigerants.

A 4E analysis (Energy, Exergy, Environmental, Economic evaluation) approach has been developed and implemented in the present disclosure for identifying low GWP refrigerants as drop-in replacements for R134a and R410A in selected refrigeration cycles, based on technical KPIs (Key Performance Indicator), flammability, environmental and economic impact. The molecular-based polar soft-SAFT EoS was used as a reliable platform for generating properties needed for the rational design of binary blends.

### Technical Evaluation of Potential Drop-In Replacement Blends in Basic Refrigeration Cycle Based on Key Performance Indicators (KPI)

The binary blend of refrigerant comprising R1243zf and R1234ze (E) satisfying the initial screening criteria mentioned in the previous subsection were then evaluated based on their technical compatibility as drop-in replacements for R134a and R410A. The technical evaluation was first carried out simulating a simple single-stage vapor compression refrigeration cycle (SS-VCRC), represented in FIGS. 1(a-c). The SS-VCRC operates with the isentropic compression of superheated vapor in the single-stage reciprocating air compressor (1-2), followed by the isobaric de-superheating of the working fluid in a series of shell-and-tube air-to-refrigerant heat exchangers (2-2*). Condensation occurs afterward, releasing both its latent (2*−3^{SAT}) and specific (3^{SAT}−3) heats to deliver a subcooled liquid phase working fluid. This is followed by temperature and pressure reductions in the electronic expansion valve (EEV) (3-4), with the multiphase mixture cooling the high-temperature heat sink in the evaporator coil by releasing its latent and sensible heats, reaching a single-phase superheated vapor (4-1). Note that the temperature-entropy (TS) diagrams for near-azeotropic blends (see FIG. 1(c)) account for their phase change (i.e., evaporation and condensation) along their TG rather than at constant temperature as with pure refrigerants and azeotropic blends.

For simulating the SS-VCRC system, the following assumptions were considered: outlet evaporator temperature (Tₑᵥ=T₁) of 263.1 K, discharge condenser temperature (T_{cond}-T₃) of 293.1 K, isentropic compression, and zero pressure drop in the heat exchangers. As reflected in FIGS. 1(b-c), a 5 K superheating and subcooling were applied to the system to lengthen the lifespan of the compressor and EEV, by preventing the formation of droplets in the compressor, while maintaining a liquid phase in the EEV. The simulations were performed using PH and TS diagrams predicted from molecular theory at the chosen conditions with ideal gas enthalpy and entropy correlations from NIST REFPROP database for each refrigerant. Table 3 and Table 4 summarize the key performance indicators and compatibility of the binary blends comprising different ratios of R1243zf and R1234ze (E).

The non-monetized key performance indicators (KPIs) for technical evaluation of drop-in replacement blends to R134a and R410A are based on volumetric cooling capacity (VCC), discharge line temperature (DLT), and condenser pressure (P_{cond}), which should be similar to the replaced refrigerant to ensure high system compatibility and minimal retrofitting. Other thermodynamic properties and performance criteria have also been included to assess the degree of blend compatibility with existing systems using R134a and R410A in SS-VCRC cycles. These include normal boiling point (NBP), pressure ratio (PR), suction density (pv), refrigeration effect (RE), power per ton of refrigeration (PPTR) and coefficient of performance (COP), also predicted using the thermodynamic model. These technical criteria are used to determine the compatibility of the short-listed blends in SS-VCRC cycles. Equal weights were given for each metric included in Table 4 for the sake of simplicity, with promising blends selected based on a 90% compatibility ratio, for further evaluation in terms of performance in advanced refrigerant cycles, overall environmental impact, and projected yearly cooling cycle cost rate. Table 5 summarizes the KPIs in liquid-line/suction line heat exchanger cycles and two-stage linear compressor systems.

Once the compatibility of promising blends (i.e., blends 1-5, 1′ and 2′) as drop-in replacements in basic SS-VCRC system, representing a benchmark model, was established, the performance of these blends in other advanced refrigeration cycles (i.e., LL/SL-HX and TSVCRC) was examined. The technical performance of the designed blends in these systems was evaluated under the same operating conditions and assumptions. Table 5 summarizes the key performance indicators of the binary blend of R1243zf and R1234ze(E) (ID 5) as compared to commercial refrigerants like R134a and R410A.

### Environmental Evaluation of Promising Drop-In Replacement Blends

Once possible blends are selected based on their technical performance, the environmental impact associated with their utilization and emissions to replace R134a and R410A is evaluated employing the total equivalent warming impact (TEWI) metric developed by the Australian Institute of Refrigeration, Air conditioning and Heating (AIRAH). TEWI is ameasure of the global warming impact derived from the direct (i.e., refrigerant leakage and end-of-life disposal) and indirect (i.e., compressor energy consumption) GHGs' emissions related to the utilization of the refrigerant in the intended application, in terms of yearly tons of equivalent CO₂ emissions. With this metric, the environmental assessment of these blends not only accounts for their GWP, but also includes the indirect impact associated with the energy consumption of the VCRC cycle, dependent on the type and efficiency of the cooling system, and the properties of the refrigerant blend, alongside with the level of decarbonization in the energy mix within a specific country also considering the country-dependent indirect emission factor. Table 6 summarizes the environmental evaluation of binary blends comprising different ratios of R1243zf and R1234ze(E). The GWP for this specific blend in the example is less than 1, thus conforming with being near azeotropic, low GWP binary blend that could be used as a drop-in replacement to R134a and R410A. Glide Temperature is represented as TG (K). The technical criteria degree of azeotropy was evaluated based on the blend glide temperature (TG), defined as the heat gradient between dew and bubble points at constant pressure and single-phase composition or, in short, the temperature variation observed during phase change at isobaric requirements. The detailed glide assessment was obtained from VLE predictions for the binary blends using the molecular theory. Binary blends with null (azeotropic) or small (near-azeotropic) glide temperatures are preferred, behaving as pure fluids in RAC systems. In the present disclosure, acceptable T_{G} was set to 0.1 K, benchmarked to the TG of the near-azeotropic blend R410A at atmospheric pressure, although this criterion can be less stringent for other cooling applications.

TABLE 6
Environmental evaluation of binary blends comprising
different ratios of R1243zf and R1234ze(E)

| | | | | | ASHRAE |
|---|---|---|---|---|---|
| ID | Blend | wt. %^{±} | GWP | T_{G} (K)* | class |
| 5 | R1243zf + R1234ze(E) | 60.0 | <1 | 0.041 | A2L |
| 6 | | 70.0 | | 0.012 | |
| 7 | | 80.0 | | 0.002 | |
| 8 | | 90.0 | | 0.000 | |

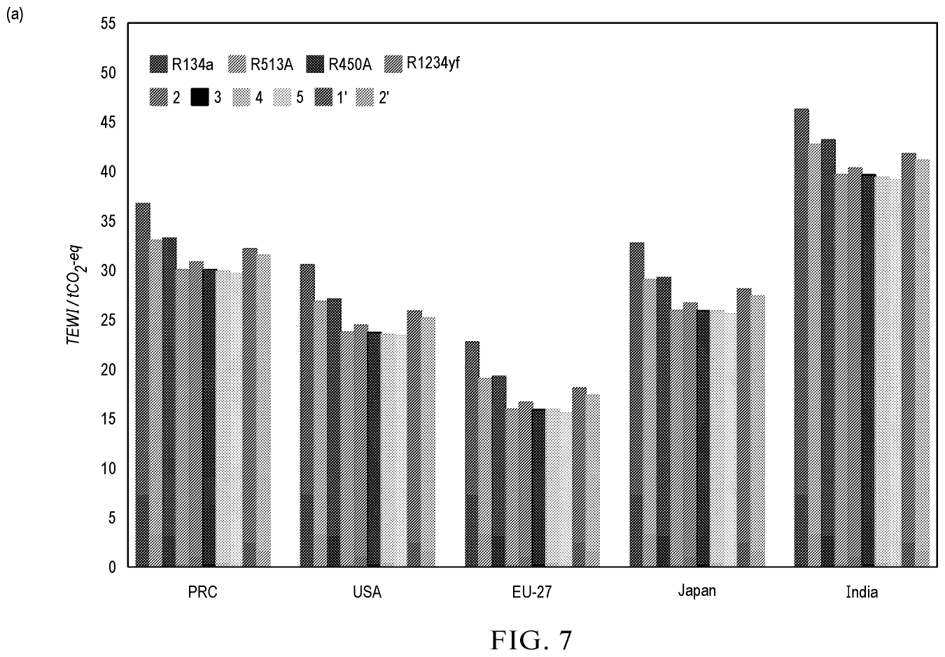

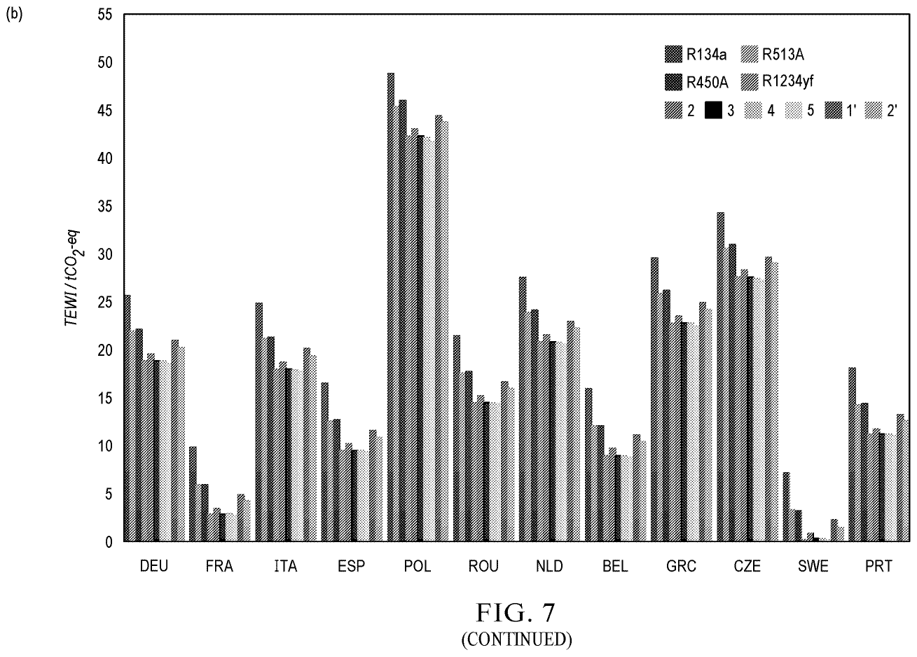

The results of the environmental impact based on the TEWI metric in SS-VCRC cycle are presented in FIGS. 7(a-b). The level of direct emissions related to the leakage rate and end-of-life cycle disposal of the working fluids were similar across all examined geographical areas (FIGS. 7(a-b), as the parameters concerned there were fixed beforehand. This is simplistic for the sake of convenience. However, it suffices for a comparative analysis. FIGS. 7(a-b) show TEWI analysis for most promising alternatives for R134a in SS-VCRC cycle, with the bar colors corresponding to the studied benchmark refrigerants and designed blends. FIG. 7(a) shows the different major HFCs producers, and FIG. 7(b) shows selected EU-27 countries, sorted by population from left to right. The strong color represents direct emissions, while the light-equivalent color stands for indirect emissions. The colors represent the different refrigerants and blends, as per the legend inside the figures. In terms of working fluids, both commercial refrigerants R410A and R134a present the highest direct emissions of 10.46 and 7.07 tCO2-eq, respectively, closely related to their high GWP. Additionally, lower direct emissions were obtained with proposed commercial replacements R32 (1.77 tCO2-eq), R450A (2.97 tCO2-eq), and R513A (3.11 tCO2-eq) within 50% lower than 3rd generation refrigerants. Clearly, the synthetic blends described in this disclosure present a major reduction in direct emissions, being almost 90% lower than R134a and R410A, with nearly negligible direct contribution for blends 1, 3, 4, and 5 [comprising 1243zf and 1234ze(E), Example 1] due to the large proportion of low-GWP HFOs in the blends (i.e., R1123, R1243yf, and R1243zf). Conversely, larger indirect emissions contributions are obtained with all working fluids, closely related to the energy source dependent on the country, and compressor work dependent on the working fluid. All drop-in replacements except for blend 5 [comprising R1243zf and R1234ze (E)], result in larger levels of indirect emissions compared to R134a.

### Economic Evaluation of Promising Drop-In Replacement Blends

The total annualized cost (TAC, C) for deploying the promising refrigerants blends in the VCRC cycles examined in the present disclosure includes the capital (CAPEX, Σ Cₖ), operating and maintenance (OPEX, Cop), environmental (Enviro Cₑₙᵥ), and set-up (Cₛₑₜ₋ᵤₚ) costs, utilized as monetized KPIs for determining the optimal drop-in refrigerant blend, and they are calculated according to the following equation:

$$\begin{matrix}TAC ( \$ \cdot {y}^{- 1} ) & \\ \dot{C} = \sum {\dot{C}}_{k} + \dot{{C}_{op}} + \dot{{C}_{env}} + {C}_{set - up} & ( 3. a )\end{matrix}$$

$$\begin{matrix}CAPEX ( \$ \cdot {y}^{- 1} ) & \\ \sum {\dot{C}}_{k} = \frac{{C}_{k} \cdot ϕ}{3600 \cdot AOT} \cdot CRF = \frac{{C}_{k} \cdot ϕ}{3600 \cdot AOT} \cdot ( \frac{i \cdot {( 1 + i )}^{n}}{{( 1 + i )}^{n} - 1} ) & ( 3. b )\end{matrix}$$

$$\begin{matrix}OPEX ( \$ \cdot {y}^{- 1} ) & \\ \dot{{C}_{op}} = \sum \dot{W} \cdot AOT \cdot {α}_{el} & ( 3. c )\end{matrix}$$

$$\begin{matrix}Enviro ( \$ \cdot {y}^{- 1} ) & \\ \dot{{C}_{env}} = {m}_{{CO}_{2} , e} \cdot {c}_{{CO}_{2}} = ( β \cdot {E}_{a} ) \cdot {c}_{{CO}_{2}} & ( 3. d )\end{matrix}$$

$$\begin{matrix}Set - up ( \$ ) & \\ {C}_{set - up} = {m}^{′} \cdot ( RP + {Tax}_{HFC} ) + {Tax}_{{CO}_{2}} ( GWP \cdot [ m \cdot L \cdot n + m \cdot ( 1 - α ) ] ) & ( 3. e )\end{matrix}$$

$$\begin{matrix}( kg ) & \\ Lifetime load {m}^{′} = m + m \cdot L \cdot n & ( 3. f )\end{matrix}$$

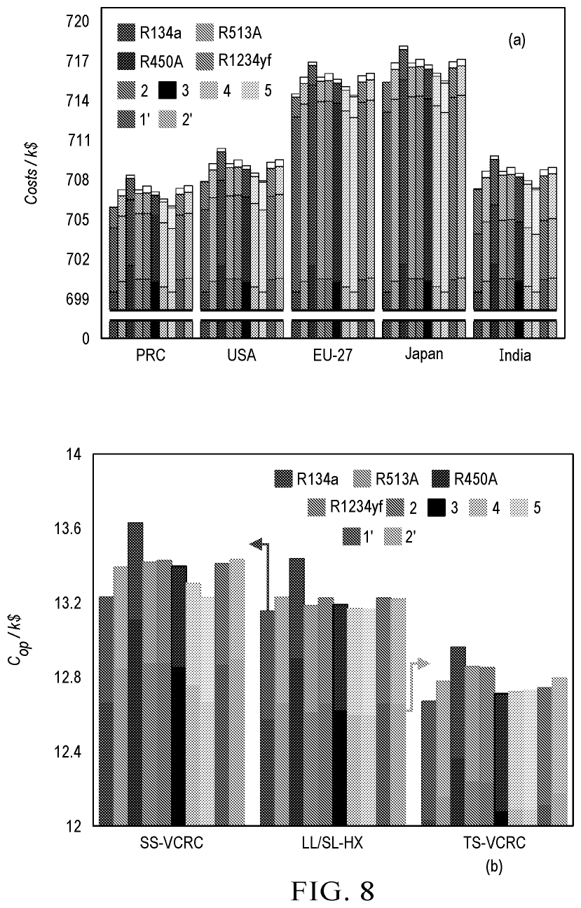

The last evaluation to assess the potential of promising blends designed in the present disclosure for short term deployment is focused on their economic assessment using monetized KPIs associated with capital, operating, maintenance, environmental, and setup costs for the selected blends, calculated from the above equation. FIG. 8(a) shows the economic analysis for most promising alternatives for R134a for the different major HFCs producers based on total costs. The colors represent the different refrigerants and blends, as per the legend inside the figures. The different portions of the bars represent the split of the total annual cost, from bottom to top (darker to lighter colors): CAPEX, OPEX, Enviro, and set-up costs, calculated from above mentioned Equation, utilized as monetized KPIs for determining the optimal drop-in refrigerant blend. FIG. 8(b) shows Economic analysis for most promising alternatives for R134a for the cycle configurations based on operating costs (left y-axis, darker colors of the bars) and environmental cost (right y-axis, lighter color of the bars) performed under the Spanish regulations, being the most restrictive within the EU-27. Colors represent the different refrigerants and blends, as per the legend inside the figures. Examining the economic viability in terms of promising blends as replacements to R134a, relatively similar costs are seen with the deployment of blend 5 (comprising 1243zf and 1234ze (E) as a replacement for R134a.

### Example 2

### Cooling Application of Binary Blend Comprising R1123 and R32

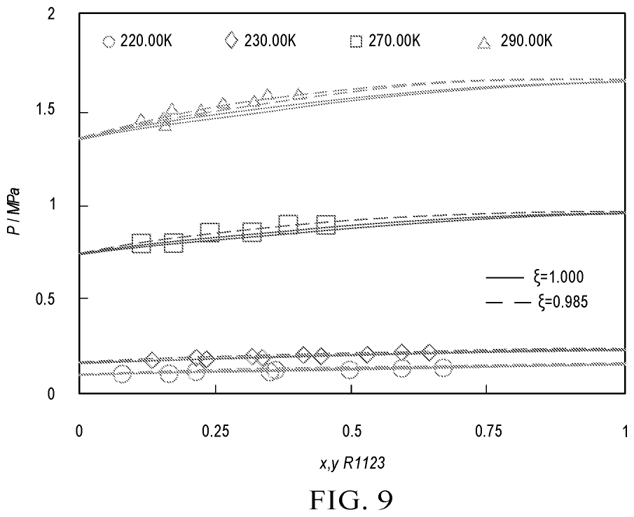

The strength of using molecular-based EoSs is also validated from the example comprising the binary blend of R1123 and R32. FIG. 9 shows the predicted VLE of the blend. In FIG. 9, symbols are experimental data and lines are polar soft SAFT calculations.

The developed 4E analysis (Energy, Exergy, Environmental, Economic evaluation) approach has been implemented in the present disclosure for identifying low GWP refrigerants as drop-in replacements for R410A in selected refrigeration cycles, based on technical KPIs (Key Performance Indicator), flammability, environmental and economic impact. The molecular-based polar soft-SAFT EoS was used as a reliable platform for generating thermodynamic properties needed for the rational design of binary blends.

### Technical, Environmental, and Economic Evaluation of Potential Drop-In Replacement Blends in Basic Refrigeration Cycle Based on Key Performance Indicators (KPI)

The binary blend of refrigerant comprising R1132 and R32 satisfying the initial screening criteria mentioned in the previous subsection were then evaluated based on their technical compatibility as drop-in replacement for R410A. The technical evaluation was carried out simulating a simple single-stage vapor compression refrigeration cycle (SS-VCRC), represented in FIGS. 1(a-c) under the same operating conditions described in Example 1, based on the same KPIs with their values in Tables 3-5. Once the compatibility of promising blends (i.e., blends 1-5, 1′ and 2′) as drop-in replacements in basic SS-VCRC system, representing a benchmark model, was established, the performance of these blends in other advanced refrigeration cycles (i.e., LL/SL-HX and TSVCRC) was examined. The technical performance of the designed blends in these systems was evaluated under the same operating conditions and assumptions. Table 5 summarizes the key performance indicators of the binary blend of R1132 and R32 (ID 1) as compared to commercial refrigerants like R410A.

Once possible blends are selected based on their technical performance, the environmental impact associated with their utilization and emissions to replace R410A is evaluated employing the total equivalent warming impact (TEWI) metric. Table 7 summarizes the environmental evaluation of binary blend comprising R1123+R32. The GWP for this specific blend in the example is 70, thus conforming with being near azeotropic, low GWP binary blend that could be used as a drop-in replacement to R410A.

TABLE 7
Environmental evaluation of binary blends comprising
different ratios of R1123 and R32

| | | | | | |
|---|---|---|---|---|---|
| | | | | | ASHRAE |
| ID | Blend | wt. %^{±} | GWP | T_{G} (K)* | class |

Study A

| | | | | | |
|---|---|---|---|---|---|
| 1 | R1123 + R32 | 90.0 | 70 | 0.099 | A1 |

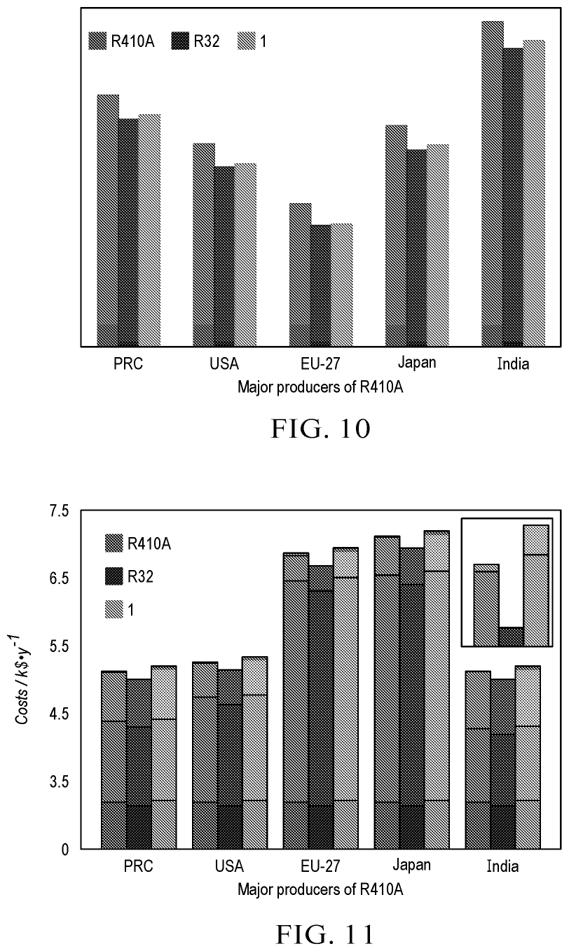

The results of the environmental impact based on the TEWI metric in SS-VCRC cycle are presented in FIG. 10, showing the environmental impact for blend 1 as an alternative to R410A in SS-VCRC cycle, with the bar colors corresponding to the studied benchmark refrigerants and designed blends, for different major HFCs producers. Clearly, blend 1 has the lowest environmental impact compared to R410A and its alternative R32. The addition of R1123 significantly helped in reducing the GWP of the designed blend, resulting in lower direct emissions (see dark bars in the figure). These results demonstrate the reduced negative environmental impact associated with the designer blend compared to traditional refrigerants.

In a similar manner, replacing R410A with blend 1 would result in retrofitting costs of similar levels to blend 3 when replacing R134a, in the range of 55.4-101.1 $·y⁻¹. FIG. 11 shows the economic analysis for most promising alternatives for R410A for the different major HFCs producers based on total costs. The colors represent the different refrigerants and blends, as per the legend inside the figures. The different portions of the bars represent the split of the total annual cost, from bottom to top (darker to lighter colors): CAPEX, OPEX, Enviro, and set-up costs, calculated from above mentioned Equation in [0063], utilized as monetized KPIs for determining the optimal drop-in refrigerant blend.

From the foregoing explanation, description and examples, it is apparent that by using molecular modeling based on thermodynamic principles, safety and cost analyses (as in 4E analyses), comprehensive system simulation, a number of azeotropic and near azeotropic blends of refrigerants have been designed for use in certain applications where the existing refrigerant options need to be phased out. These blends as described in the present disclosure are offer distinct advantages over the existing refrigerants. In particular, the blends in the present disclosure exhibit:
1. Global Warming Potential (GWP) less than 150.
2. No Ozone Depletion Potential (ODP).
3. Non-toxic (Class A according to ASHRAE classification).
4. Non-flammable (Class 1) or mildly-flammable (Class 2L according to ASHRAE classification).
5. Pure components or near-azeotropic blends (Glide temperature<0.1 K) with similar normal boiling temperature and condensation pressures of the refrigerant to be replaced.
6. Have similar volumetric cooling capacity (i.e., amount of refrigerant to deliver a specific cooling capacity), condenser pressure, and discharge line temperature than R134a or R410A, depending on the application.
7. Having similar system performance energetic efficiency, and energy consumption.

What makes the blends described in the present disclosure desirable is that these possess the above desirable properties and are environment friendly when compared to the existing refrigerants. In addition, these blends also have well established chemical and material compatibility with the existing refrigerants and therefore could be used in the existing systems with minimum modifications.

While the disclosure has been described with reference to an exemplary embodiment(s), it will be understood by those skilled in the art that various changes may be made, and equivalents may be substituted for elements thereof without departing from the scope of the embodiment(s). In addition, many modifications may be made to adapt a particular situation or material to the teachings of the embodiment(s) without departing from the essential scope thereof. Therefore, it is intended that the disclosure is not limited to the disclosed embodiment(s), but that the disclosure will include all embodiments falling within the scope of the appended claims. Various examples have been described. These and other examples are within the scope of the following claims.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus, the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

Various examples have been described. These and other examples are within the scope of the following claims.

1. A refrigerant that is near azeotropic and comprises a binary blend of more than one of R1243zf, R1234ze(E), R1234yf, R152a, R1123, R32 refrigerants.

2. The refrigerant according to claim 1, wherein the binary blend has a composition of 60% to about 90% by weight of R1243zf, and a remainder of said refrigerant is R1234ze(E).

3. The refrigerant according to claim 1, wherein the binary blend has a composition of 80% to about 90% by weight of R1234yf, and a remainder of said refrigerant R152a.

4. The refrigerant according to claim 1, wherein the binary blend has a composition of 90% by weight of R1123, and a remainder of said refrigerant R32.

5. The refrigerant according to claim 1, wherein the refrigerant has a global warming potential of less than 150.

6. The refrigerant according to claim 1, wherein the refrigerant has an ozone depletion potential of zero.

7. (canceled)

8. (canceled)

9. (canceled)

10. (canceled)

11. The refrigerant according to claim 1, wherein the refrigerant has a Glide Temperature of <0.1 K.

12. (canceled)

13. A method of retrofitting an existing heat transfer system that includes an existing refrigerant, the method comprising:
unsealing the heat transfer system to gain access to the existing refrigerant;
removing substantially all of the existing refrigerant from the heat transfer system;
replacing the existing refrigerant with a refrigerant that is near-azeotropic and comprises a binary blend of more than one of R1243zf, R1234ze(E), R1234yf, R152a, R1123, R32 refrigerants;
resealing the heat transfer system.

14. The method according to claim 13, wherein said binary blend has a composition of 60% to about 90% by weight of R1243zf, and a remainder of said refrigerant is R1234ze(E).

15. The method according to claim 13, wherein the binary blend has a composition of 80% to about 90% by weight of R1234yf, and a remainder of said refrigerant R152a.

16. (canceled)

17. (canceled)

18. (canceled)

19. The method according to claim 13, wherein the binary blend has a safety classification of A2L or A1.

20. (canceled)

21. (canceled)

22. (canceled)

23. The method according to claim 13, wherein the system comprises a low to medium refrigeration system.

24. (canceled)

25. (canceled)

26. The method according to claim 13, wherein the system comprises one operated with advanced cooling cycles and including liquid-line/suction line heat exchanger cycles.

27. The method according to claim 13, wherein the system comprises two-stage linear compressor systems.

28. A heat transfer system comprising a compressor, a condenser, and an evaporator in fluid communication and operating with an evaporator temperature (ET) from about 243 K to about 263 K; condenser temperature (CT) from about 293 K to about 315 K, and a refrigerant in said system, said refrigerant comprises a binary blend of more than one of R1243zf, R1234ze(E), R1234yf, R152a, R1123, R32 refrigerants.

29. The system according to claim 28, wherein the degree of superheating at an evaporator outlet is about 5 K and the degree of subcooling at a condenser outlet is about 5 K.

30. The system according to claim 28, wherein said binary blend has a composition of 60% to about 90% by weight of R1243zf, and a remainder of said refrigerant is R1234ze(E).

31. The system according to claim 28, wherein the binary blend has a composition of 80% to about 90% by weight of R1234yf, and a remainder of said refrigerant R152a.

32. (canceled)

33. (canceled)

34. (canceled)

35. (canceled)

36. (canceled)

37. The system according to claim 28, wherein the system comprises one operated with advanced cooling cycles and including liquid-line/suction line heat exchanger cycles.

38. The system according to claim 28, wherein the system comprises two-stage linear compressor systems.
